(19) United States
(12) Patent Application Publication
(10) Pub. No.: US 2008/0299953 A1
(43) Pub. Date: Dec. 4, 2008

(54) Mobile web system providing interchangable service with a mobile device

(76) Inventor: Bindu Rama Rao, Laguna Niguel, CA (US)

Correspondence Address: Bindu Rama Rao, 21 Henley Drive, Laguana Nigel, CA, 92677, US

(21) Appl. No.: 12/011,238

(22) Filed: Jan. 25, 2008

Related U.S. Application Data
(63) Continuation-in-part of application No. 11/807,670, filed on May 30, 2007.

(51) Int. Cl. H04M 3/42; G06F 7/00

(52) U.S. Cl. 455/414.1; 707/3; 707/E17.014

(57) ABSTRACT

The present invention deals with a ‘mobile web system’ that provides access to a mobile service addressing secured communication/interaction among a group of friends, between an individual and a plurality of friends groups, etc. The sender of communications sends a query (audio or textual for example) or a questionnaire to one or more lists of friends/colleagues/experts and receives collected responses from them. The recipients may be registered members of a portal or other individuals whose contact information is known. The mobile service is augmented by an interchangeable service that is available to a user on his/her mobile phone. Using the service, interactive media, questionnaires and multimedia content can be communicated to friends and feedback/responses can be received.

### CROSS REFERENCES TO RELATED APPLICATIONS

The present patent application is a continuation-in-part of, claims priority to, and makes reference to U.S. non-provisional patent, Ser. No. 11/807,670, entitled “MOBILE DEVICE AND SERVER CAPABLE OF SUPPORTING ADHOC QUESTIONNAIRES”, filed on May 30, 2007, docket number BRR2006-US04-05-U1. The complete subject matter of the above-referenced U.S. patent application is hereby incorporated herein by reference, in its entirety.

The present patent application makes reference to U.S. non-provisional patent, Ser. No. 11/821771, entitled “SYSTEM FOR PROVIDING INTERACTIVE USER INTEREST SURVEY TO USER OF MOBILE DEVICE”, filed on Jun. 25, 2007, docket number BRR200704US02. The complete subject matter of the above-referenced U.S. patent application is hereby incorporated herein by reference, in its entirety.

This patent application makes reference to U.S. provisional patent, Ser. No. 60/860700, entitled “AUDIO GUIDED SYSTEM FOR PROVIDING GUIDANCE TO USER OF MOBILE DEVICE ON MULTI-STEP ACTIVITIES”, filed on Nov. 22, 2006, docket number BRR2006US07. The complete subject matter of the above-referenced U.S. patent application is hereby incorporated herein by reference, in its entirety.

This patent application makes reference to U.S. Provisional Patent Application Ser. No. 60/524568, entitled “QUESTIONNAIRE NETWORK FOR MOBILE HANDSETS,” filed on Nov. 24, 2003, docket number BRR2003US03. The complete subject matter of the above-referenced U.S. Provisional Patent Application is hereby incorporated herein by reference, in its entirety.

This patent application makes reference to U.S. patent application Ser. No. 10/985702, entitled “QUESTIONNAIRE NETWORK FOR MOBILE HANDSETS,” filed on Nov. 10, 2004, docket number BRR2003US03-U1. The complete subject matter of the above-referenced U.S. patent application is hereby incorporated herein by reference, in its entirety.

This patent application makes reference to U.S. Provisional Patent Application Ser. No. 60/530175, entitled “QUESTIONNAIRE NETWORK FOR MOBILE HANDSETS AND A TRADING SYSTEM FOR CONTRACTS ON USER COMMITTMENTS TO ANSWER QUESTIONNAIRES,” filed on Dec. 17, 2003, docket number BRR2003US04. The complete subject matter of the above-referenced United States Provisional Patent Application is hereby incorporated herein by reference, in its entirety.

### BACKGROUND

1. Technical Field

The present invention relates generally to a mobile-web server system and particularly to a web portal that a user can employ to communicate or interact with a plurality of friends who may be using a mobile phone or a computer.

2. Related Art

Currently mobile default services from a service provider are confined to certain geographic locations such as major cities, states or a country. Thus when a mobile user subscribes to particular services, he will not be able to avail of those services when he is away from those geographic territories, unless he pays for an expensive roaming plan. This problem is most likely to be faced by mobile community and international travelers. Also some of the specially subscribed services will expire after a specified subscription period. In such situations the subscribed services will be underutilized or simply gets lapsed after the subscription period. In addition, due to roaming chargers that are often prohibitive, mobile users often do not access the services they have subscription to. Service providers do not have service agreements with all other service providers and therefore, for a mobile user, quite often the service is unavailable even if the mobile user is willing to pay extra for the privilege of accessing his services on a foreign network, such as in a foreign country.

Currently, a group of people can interact with each other using social networking portals or websites. Social networking websites such as Facebook and MySpace. They allow a member to post some messages and share some pictures with their friends. For example, a subscriber can post his information, including pictures, and let his friends access them online. However, these social networking groups do not facilitate interactions beyond simple message sharing and picture sharing. For example, it is not possible to ask opinions, or seek answers to questionnaires form a plurality of friends and seek an instantaneous or even a quick response from them. In addition, it is not possible to communicate interactive media, such as questionnaires, audio assisted guided activities, interest inquiry surveys, etc. with online friends easily, quickly and efficiently, and seek their inputs systematically, on these social websites.

In particular, interaction between friends in the social network supported by most social networking websites is restricted to other members who have signed up with the social network. In addition, interactions are limited to information access using the social networking portal as the common platform/common means of communication. Thus, a user can post a message to the social network using the social networking portal, and have his friends view it. Or the user can play a game at the portal. However, friends who are not members of such social groups cannot participate or communicate effectively with those members who are.

Most mobile devices subscribe to an SMS (Short Message Service) service, and it is available for subscription in most operator networks. In general it has its own limitation with its confinement to textual contents, in general. Also, people send SMS messages typically to other users on their mobile devices. Sending complicated queries or questionnaires or multiple choice selections to users on their mobile phones over SMS is typically not possible. Information in the form of multimedia contents are often needed and perhaps accessible by users of mobile devices. However, there are no standard techniques that are developed to deliver multimedia contents to the mobile phones of users, more so when different users employ a heterogeneous set of mobile devices, with different makes and models, and with varying capabilities.

There are occasions when a user of a mobile device needs to send a query comprising multimedia content with text, audio, or video clips, etc. to a plurality of friends. There is no easy way to send such queries to multiple devices, that too easily. Sending email is cumbersome, and often recipients do not have software required to view them when such multimedia content is sent over email. When queries with multimedia content are required to be sent to a group of users/friends, it is currently less likely that they can be delivered on to the mobile phones and have users respond back. A sender has to take care of the needs of different makes and models, and provide various appropriate types of content and package them differently. Often, this problem necessitates content reformatting depending on the recipient mobile device's capabilities, and a sender is often incompetent to do that, such as for an email with such attachments.

Currently, if a multimedia message or query requiring responses from the recipients needs to be sent to a group of users, individual responses are received by a sender, from one respondent at a time, such as over email services, with one email response at a time, with often no prescribed/common format for the responses. The sending mobile device receives one or more responses, with the sender having to collect the responses, as necessary, as they arrive, if they arrive. Thus the responses received from different mobile phone users, such as over email, from a group of recipients to a multimedia message or query sent by them, needs to collected by the user, and manually collated and reviewed by the person receiving the responses. This has to be done using the mobile device resources, even though the mobile device is a constrained device. At present there are no services capable of handling sending of interactive media to a group of mobile devices, especially wherein the recipients can respond back to the sender. In addition, there are no services available wherein the users can be either mobile device users or web users, or both interchangeably.

Group interactions, although minimal, are currently threatened with security issues. Eavesdropping on a transmission channel happens quite often in some special application domains (in intelligence, etc.). Thus sensitive information is likely to be lost to an unauthorized person. Personal information such as banking account number, pin number, passwords are prone to be easily accessed by unauthorized users.

Currently, there is no proper tools that can be used by a mobile user to manage mobile to mobile interactions. There are fewer tools or services that help interactions between groups of users wherein each of the groups of users can be using a mobile device, a computer or even a web portal. For example, there are no services available today that provide for the registration and management of a group of friends/recipients by a user (a sender of interactive multimedia messages for example) wherein each of the individuals in the group of friends/recipients may employ any one (or more) of a computer, an email service, a mobile device or a web portal.

Creating adhoc/on-the-fly services for users is very complicated, if not impossible currently in the mobile industry. They are also quite difficult to be made available as an adhoc service on the current web portals/websites. Even when such adhoc services are created, mobile phone users will not be able to easily subscribe to them without manual intervention for most of these new adhoc services. Also, it is hard to standardize the delivery of the special services for e.g. News, Realty, Mobile banking, etc. with the required level of security, for a long time to come. For example, service components such as online payment, online renewal etc., are not adequately standardized yet and they are not implemented on a secured standard principles in general. This results in failure of mobile users in getting an optimum quality of the service when they decide to subscribe to new adhoc services (even such services can be created in the future).

Also the availability of new/special services typically depends on the mobile service provider's ability to support new services. New services that may incorporate ad (advertisement) delivery are being planned by the industry. However, there are few controls on delivery of ads to users who may be the wrong targets or unhappy recipients of such ads. When free ads are delivered on the mobile network today, there are no mechanisms built into users account to regulate their delivery, and mobile ads often are delivered to the wrong recipients or to unsuitable recipients.

Currently mobile services and registration to mobile services is geographic location specific (say restricted to a country) or network specific, which is a serious limitation. When a person is away from the geographic location of his/her registration or is traveling in a foreign country or roaming on a different network, it becomes impossible to access all data or services subscribed to, and often details of information from his/her registered accounts are not retrievable either. If a user is traveling away from his home network/region for a long time, the user's registered accounts are most likely to be made inoperative by their service providers due to certain terms and conditions. Information that flows into such accounts will be bounced back on the network causing a serious problem of unwanted traffic and congestion. A more unfortunate side effect of frequent travel is the inability to access emails, voicemails, SMS messages received in an recipient's mailbox from a roaming network, typically from a foreign country. Although the information may be saved for access by the user, they are inaccessible or prohibitively expensive for access from the mobile device due to one or more reasons.

Most social networking portals or Internet forums are a web application for holding discussions and posting user generated contents. Internet forums are also commonly referred to as web forums, message boards, discussion boards, discussion groups, etc. The terms “forum” and “board” may refer to the entire community or to a specific sub-forum dealing with a distinct topic.

The concept of virtual community pre-exists with computer networking in the form of newsgroups. The term virtual community meant an interaction of members of group on the network through an online interaction by posting their discussion messages on a central server which acts as a bulletin board. This type of interaction also includes E-mail, telephone calls, etc. A newsgroup is a forum which facilitates a computer user to register and become a member of defined group. These group members can share their views and discuss on subject of their common interest. Each member can post their views and opinion on a centrally hosted server which provides an interface among the members through some server application programs. Connecting to such central servers required dialing over telephone lines or some leased lines, which would be a cumbersome and costly setup. Such facilities are not accessible and affordable by all class of people.

Subsequent to newsgroup forum that existed over networks such as WAN (Wide Area Network), LAN (Local Area Network), etc., the old computer networks expanded as the Internet, becoming a world wide web, along with which the newsgroup forums evolved as internet forums (or groups). The evolution of the Internet forums circumvented the issue of accessibility to the central server which stores all the posted discussions or opinions on a common topic of interest of an internet group. A group member could post his opinion or suggestion on a central server by logging in through the Internet so that it could be accessible, written into and readable by all the group members.

Some of the issues with Internet forums are multiple posting of the opinions, spamming, internet trolls, etc. This resulted in the phishing during internet banking, posting of derogatory and inflammatory messages, etc. on the message boards. In other words it is the issue of moderating or controlling the forum, for the desired results, turned into a management headache.

Further limitations and disadvantages of conventional and traditional approaches will become apparent to one of ordinary skill in the art through comparison of such systems with the present invention.

### BRIEF SUMMARY OF THE INVENTION

The present invention is directed to apparatus and methods of operation that are further described in the following Brief Description of the Drawings, the Detailed Description of the Invention, and the claims. Other features and advantages of the present invention will become apparent from the following detailed description of the invention made with reference to the accompanying drawings.

### BRIEF DESCRIPTION OF THE DRAWINGS

FIG. 1 is a perspective block diagram of a mobile web system that is used by a user to send interactive media (such as voice queries, audio assisted questionnaires, etc.) to multiple recipients and to receive a collated response from the recipients;

FIG. 2 is a block diagram showing exemplary components of a ‘registration manager’ employed by the distribution server in accordance with the present invention;

FIG. 3 is a block diagram of an exemplary mobile phone API built in accordance with the present invention;

FIG. 4 is a block diagram with exemplary components of a distribution server APIs in accordance with the present invention;

FIG. 5 is an exemplary snapshot of a function selection screen of the mobile phone with client software in accordance with the present invention;

FIG. 6 is an exemplary screen snapshot of a mobile phone depicting the review of the responses (to queries, questionnaires, interactive media, etc.) received from the members of one or more friends groups, in accordance with the present invention;

FIG. 7 is a Registration screen snapshot of a mobile phone presented to the user during registration on a distribution server, in accordance with the present invention;

FIG. 8 is an exemplary snapshot of a ‘New friends group’ creation screen in a mobile phone used by a user to create a new group comprising a list of references to friends, the new friends group being stored on a distribution server in accordance with the present invention;

FIG. 9 is a flowchart showing exemplary operations performed by a service client (such as a Qello client from Vaudiofone) on a mobile phone in accordance with the present invention; and

FIG. 10 is a flowchart for exemplary operations performed by the distribution server during the interaction with the mobile phone in accordance the present invention.

### DETAILED DESCRIPTION OF THE DRAWINGS

The present invention provides an elegant means of interaction with groups of friends/members in a social group, such as a group of colleagues, students of a class or college friends. Also, the present invention expands the mode of interaction between friends beyond the Internet/network domain to also encompass interactions over the mobile network (wireless, cellular, etc.) leading to the seamless interactions and communication of interactive multimedia between groups of users spanning the Internet as well as the mobile network domains. In particular, the present invention provides for interchangeable access to the same or similar service from a web portal and from a mobile device of a user, thereby making the service accessible even when the user is traveling and does not have inexpensive access to his service provider in a foreign country, where the user is likely to have Internet access in some other mode. Thus, in accordance with the present invention, a user can access new services, and browse over interactive media (and respond to it) over the web (using portals), at home using a computer or over a mobile phone, using a mobile service that is interchangeably accessible from both the mobile device as well as over the Internet from a web portal/social networking website.

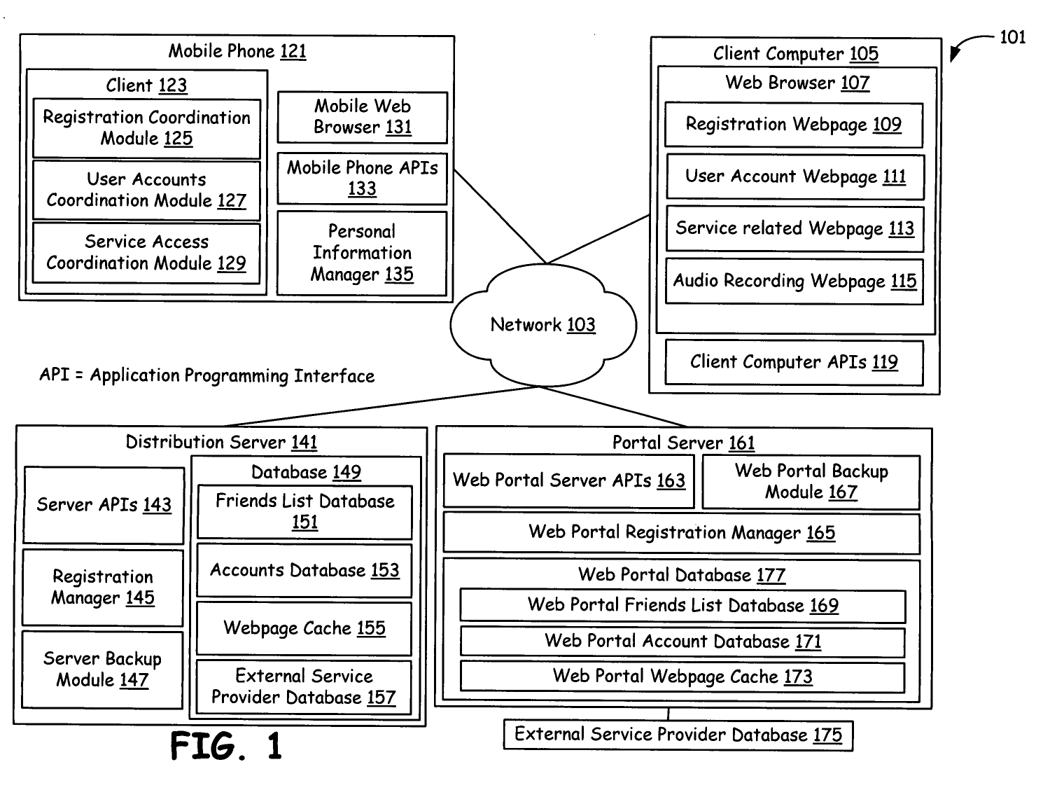

FIG. 1 is a perspective block diagram of a mobile web system 101 that is used by a user to send interactive media (such as voice queries, audio assisted questionnaires, etc.) to multiple recipients and to receive a collated response from the recipients. The recipients can use at least one of their mobile phones, a computer/browser or an email service to receive the interactive media from the sender and send their responses. The sender employs a mobile phone 121 or a client computer 105 to send the interactive media. The sender selects one or more lists of recipients from a list of several recipient lists, as targets for the interactive media to whom the interactive media will be sent and from whom responses will be received, collected, and optionally collated. The responses are presented to the sender in one group of responses, or in a multiple groups of responses. For example, responses is presented to the sender in two groups, one with responses received immediately within the first 5 minutes of sending, and a second group of responses that are received after the first 5 minutes.

The sender experiences the same features/screen flows while using either a client 123 in the mobile phone 121 or web pages provided by a portal server 161 (such as a AskFreinds web portal from Vaudiofone), that is accessed using the client computer 105 (for example). The user can employ either the client 123 in the mobile phone 121 or the web browser 107 in the client computer 105 to register for service, setup an account, access service related information, such as viewing interactive media, and record audio responses as necessary to questions/queries sent by others. In addition, the user can use the client computer 105 to access interactive media sent to them by other users, review them, and to respond to them. For example, the web browser 107 can be used to review received interactive media by accessing them from the portal server 161.

In accordance with the present invention the distribution server 141 communicatively coupled to the mobile phone 121 facilitates the interaction with the mobile phone 121. The mobile phone 121 user can open an account from his/her mobile phone 121 in a group called ‘friends group’ that is maintained at the distribution server 141, and subsequently synchronized with the portal server 161. The client 123 software that runs on a mobile phone 121 facilitates the registration of a user, the setup of a friends group by the user, and interactions with other members of the friends group by the user. The client 123 software (such as a Qello client from Vaudiofone) makes it possible to send interactive media, such as voice messages or queries, to one or more recipients, by the user of the mobile phone 121.

The distribution server 141 comprises a database 149 that stores the mobile phone user's personal details. The database 149 comprises a friends list database (151). The registered names in the friends list database 151 are associated with the corresponding user's account in an accounts database 153 that comprises account details, settings, configurations, etc. Typically, a mobile user's registered user name and his/her mobile numbers are the search keys in the friends list database 151.

Similarly a user of a client computer 105 can register into the friends list database 161 of a portal server 161, employing one or more web pages provided by the portal server 161. The portal server 161 comprises a web portal database 177 that is used to store user accounts created from the client computer 105 (for example), friends lists, etc. The web portal database 177 comprises the web portal friends list database 169, a web portal account database 171 a web portal webpage cache 173 and a web portal external service provider database 175.

The web portal friends list database 169 has entries associated with the corresponding user accounts in the web portal accounts database 171, where details of user accounts are maintained. A registered user from the client computer 105 provides his/her name, e-mail address, account details, preferences, etc. during a registration process. The web portal friends list database 169 is used to keep track of friends lists for each registered user. If the friends are themselves registered users, then corresponding entries exist in the web portal account database 171. For those friends who are not yet registered users, the web portal friends list database 169 stores contact information such as one or more of a phone number, a email address, an IP address, a mobile device serial number, etc. In general, for all registered users, their friends list is synchronized between the web portal database 177 and the database 149 of the distribution server 141. For example, the friends list for all registered users is synchronized with the appropriate database and tables in the distribution servers 141 and the portal server 161. A user can change a friends list from the user's mobile phone 121 or the client computer 105, and the changes/modifications are noted and made available for access from the portal server 161 or the distribution server 141.

The mobile web system 101 is used by a user to send interactive media (such as voice queries) that require a response from recipients. The recipients can respond back, and the mobile web system receives, collates them for the sender and communicates it to the sender. The sender receives the responses, employing the mobile phone 121 or the mobile web portal 161, with similar user experiences provided by both the mobile phone 121 and the mobile web portal 161.

The mobile phone 121, the client computer 105, the distribution server 141, and the portal server 161 are all communicatively coupled to each other via a network 103. Network 103 is one of an Internet, a public network, a private network, a cellular wireless network, a WLAN network, a WiMAX network, etc., or a combination of these. The mobile phone 121 and the distribution server 141 interact over the network 103 for delivering interactive messages to the user of the mobile phone 121 and for collecting responses to interactive messages that are reviewed and responded to by the user of the mobile phone 121. The mobile phone 121 and the distribution server 141 also interact over the network 103 to forward interactive messages sent by the user of the mobile phone 121 to one or more recipients (such as those on a friends list).

In accordance with the present invention the client 123 software runs on the mobile phone 121 for facilitating the sending of an interactive media, such as an ad-hoc query, to one of a plurality of friends lists/groups, and for receiving the responses from the members of the friends list/group. The client 123 can be downloaded from the distribution server 141. In one embodiment, the URL for downloading the client 123 is sent to the mobile phones of the friends (on the friends list) who can subsequently download a copy of the client 123 and install in on their own recipient devices/mobile phones. By running the client 123 on their mobile phones the recipients can register on the distribution server 141 and have entries created in the database 149.

The user of the mobile phone 121 can register using the client 123 on the mobile phone and create his own friends list/group, such as by searching/selecting for his/her friends from data available in the friends list database 151. In accordance with the present invention, a subset of the individuals (friends) retrieved in these searches end up being part of a new friends list created by the user. The user can select any number of friends from the friends list database 151 and define practically any number of friends groups and give an arbitrary name to each of friends groups, for e.g. ‘Friends’, ‘Colleagues’, ‘Artists’, ‘Architects’, etc. Interactive media created/uploaded by the user can be targeted to one or more of these friends groups. For example, an audio recording created by the user using the mobile phone 121 inquiring about some activity can be sent to one or more friends groups by the user, and responses sent by the friends (who are recipients of the interactive media) are collated and presented to the user by the distribution server 141. The user can receive/review the responses on the mobile phone 121. These responses are also made available to the user via the portal server 161, which may be accessed by the user via the client computer 105.

Interactive media created by the user using the client computer 105 and uploaded by the user to the portal server 161 for distribution to friends, can be communicated to one or more of these friends groups by the portal server 161. For example, an audio recording created by the user using the client computer 105 inquiring about some activity can be sent to one or more friends groups by the user, and responses sent by the friends (who are recipients of the interactive media) are collated and presented to the user by the distribution server 141. The user can receive/review the responses on the mobile phone 121. These responses are also made available to the user via the portal server 161, which may be accessed by the user via the client computer 105.

Each friends group comprising one or more friends provides at least one reference to the friends, i.e. at least one contact information, such as an email address, a phone number, an account information, a user name, etc. The distribution server 141 is capable of determining a mode of contact with the user, employing one or more of the contact information provided, such as an email address, a phone number, an account information, a user name, etc. For example, if a mobile phone number has been provided, the interactive media is communicated to the mobile phone of the user and responses are received and collated. If the email address has been provided, an email notification is provided with an URL of the interactive media, and with an optional link to a registration page. If the URL of the interactive media is exercised by the recipient, it takes the recipient to a webpage hosted by the portal server 161 that can be used by the recipient to review the interactive media and respond to it if necessary. In one embodiment, when the email address of a friend has been provided, an email notification is provided to the recipient with a copy of the interactive media attached. The recipient can view the interactive media and respond back. In a related embodiment, the recipient can optionally download a client software that facilitates review and response generation, a link to the downloadable client also being provided along with the email notification.

In one embodiment, a network system 101 comprises a mobile device 121 and a mobile web system, which is a combination of the portal server 161 and the distribution server 141. The network system 101 also comprises a group of other devices, such as the client computer 105. For example, the group of other devices comprises at least one additional mobile device or at least one personal computer communicatively coupled to the network system 101. The group of other devices typically comprises other mobile devices and devices capable of communicatively coupling with the mobile web system and interacting with the mobile web system, such as the client computer 105 that has a browser 107. The mobile device 121 provides a service that facilitates communicating with users of the group of other devices and receives a collected responses from the group of other devices on the mobile device 121. The mobile web system also provides the same or similar service that facilitates communicating with users of the group of other devices and receiving the collected responses from the group of other devices on the mobile web system.

The mobile web system facilitates receiving of the collected responses from the group of other devices when the service is provided by the mobile device. The mobile device facilitates receiving of the collected responses from the group of other devices when the service is provided by the mobile web system. The collected responses are, in one embodiment, collated, wherein the collected responses are each one of an audio response, a textual response, a multiple choice response, a video response, a graphic response and a combination of these. In a related embodiment, the collected responses are received in one or more groups wherein the collected responses are each one of an audio response, a textual response, a multiple choice response, a video response, a graphic response and a combination of these.

The network system 101 facilitates communication wherein a first user of the mobile device 121 communicates an audio question form the mobile device 121 to at least one of the users of the group of other devices and receives a collected responses from the at least one of the users on the mobile device. The first user of the mobile device 121 communicates an audio question from the mobile device to at least one of the users of the group of other devices and receives a collected responses from the at least one of the users on the mobile web system, for example by using a computer communicatively coupled to the mobile web system, such as the client computer 105. The first user of the mobile device 121 also communicates an audio question from the mobile device to at least one of the users of the group of other devices and receives a collected responses from the at least one of the users on the mobile web system employing an appropriate user account on the mobile web system. Such user accounts are typically created by the first user before communicating an audio question to one or more friends, who may also be registered users of the mobile web system.

The network system 101 makes it possible for a service provider to provide one or more services, such as those that help a user in creating a questionnaire, communicating the questionnaire with the group of other devices and receiving the responses from users of the group of other devices. It also makes it possible for a user to create an audio query, communicate the audio query to the group of other devices and receive the responses from users of the group of other devices and review the responses, wherein the responses are each one of an audio response, a textual response, a multiple choice response, a video response, a graphic response and a combination of these.

In one embodiment, a network system 101 supports a plurality of mobile devices as the users of these mobile devices send queries to each other, receive responses from each other in collections of responses, etc. The distribution server 141 interacts with the plurality of mobile devices to communicate a query generated by a user (such as using the mobile phone 121 or he portal server 161) and to receive a plurality of responses. The portal server 161 provides web pages to enable creation of queries, sending of queries, responding to queries and reviewing the responses. The distribution server 141 facilitates the distribution of the user generated query (or pre-created canned queries in some embodiments) created by a user. It also facilitates the collection of the plurality of responses from the various recipients. The portal server 161 facilitates the review of the plurality of responses from the various recipients. The distribution server 141 also facilitates the review of the plurality of responses from one of the plurality of mobile devices by the user.

In a related embodiment, the query is created by the user using one of the portal server 161 and the one of the plurality of mobile devices, such as the mobile phone 121. The query is, for example, an audio query and the plurality of responses are all audio responses that are collected by the distribution server 141 and presented in one or more groups to the user by the portal server 161, or by the mobile phone 121. In general, the query can be one of an audio query, a textual query, a video query and a combination of these. Each of the plurality of responses is one of an audio response, a textual response, a multiple choice response, a video response, a graphic response and a combination of these. The portal server 161 facilitates the creation of the query employing the web pages, wherein the web pages are accessed by the user, by using a client computer 105 for example.

In general, the portal server 161 facilitates the review of the plurality of responses by the user employing the web pages. It facilitates registration by a user to create an user account, wherein the user account can be used by other users as an entry into a list of recipients. It facilitates registration of an user account by a second user thereby creating a second user account on the portal server. The distribution server 141 facilitates communication of the query to at least one of the plurality of mobile devices currently supported and accessible by the network system 101. The at least one of the plurality of mobile devices is specified as one of a list of recipients for the query by the user. Some of the users on the list of recipients may not have registered yet with the portal server 161 and may not have a user account. For example a mobile device owned by a third user may have an entry created/associated in a list of recipients used by a first user who sends a query. For example, a mobile phone number of a mobile device associated with a third user may be in a list of recipients used by a first user to send a query. The third user can respond to the query using his mobile device, or by using the portal server 161.

In general, the distribution server 141 facilitates communication of a user generated interactive media, such as an audio query or a questionnaire, to a second user account on the portal server 161 when the second user account is specified as one of a list of recipients by the user for the query. The portal server 161 facilitates creation of a second response by the second user, among the plurality of responses created by different recipients, to the query employing the second user account and the query. Similarly, the portal server 161 facilitates creation of a third response, among the plurality of responses, by the third user to the query, wherein the third user does not yet have a user account, but is still allowed to review the query and provide a response, such as an audio response or a textual response.

In a different embodiment, a mobile web system, which incorporates portions of the distribution server 141 and the portal server 161, makes it possible to use a service for sending queries and receiving collected responses, and for sending interactive media to a group(s) of friends and receiving feedback from them that are collected, optionally collated and presented to the sender in a mobile phone 121 or by using one or more appropriate web pages provided by the mobile web system. The mobile web system comprises a server for communicating a query and receiving responses. The server comprises a plurality of lists of recipients, each of the plurality of lists of recipients represented by at least one of an email address, a phone number or a user name, an user account etc. The server also comprises a query creation component that facilitates creation of a the query by a sender wherein the query comprises at least one of an audio question, a textual question, a multiple choice question, a video question and a combination of these. It also comprises a query response collection component that collects recipient responses from a plurality of recipients, wherein each of the plurality of recipients is associated with at least one of the plurality of list of recipients. In addition, it comprises a response presentation component that displays received recipient responses from the plurality of recipients to the sender.

In a related embodiment, the plurality of lists of recipients comprises at least one list retrieved from an external social networking portal, such as Facebook or Myspace. For example, the user sending a query can select one or more list of friends and colleagues, one of those lists being a list of friends retrieved from the user's own Facebook account, employing an appropriate application programming interface. Thus, a user may have another of those list of recipients extracted from the user's Myspace account. The user's query is created by the user, using the server or by using the mobile device 121, and communicated to at least one of the lists of recipients that the user has created, including those retrieved from external social networking websites. The server also comprises a query response creation component that facilitates creation of the recipient responses by the users of the at least one of the lists of recipients. Each of the recipient responses comprises at least one of an audio response, a multiple choice response, a textual response, a video response and a combination of these.

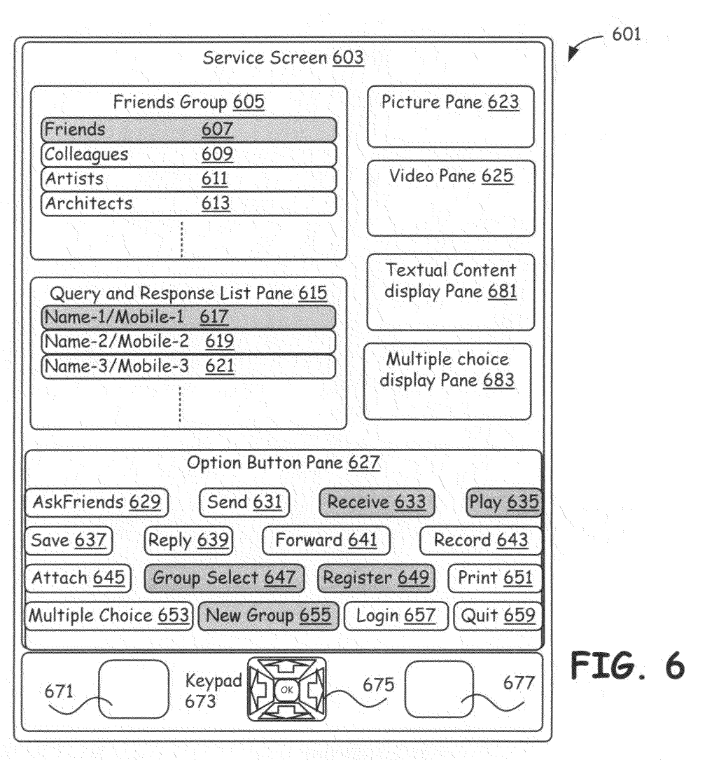

The mobile phone 121 facilitates management of friends lists by the user, such as creating new lists, adding to existing lists, modifying lists, deleting lists, etc. A ‘New group’ soft button 655 (FIG. 6) option provided on the mobile phone 121 facilitates the definition of a new groups of friends/colleagues/recipients by the user. A ‘Group select” soft button 647 (of FIG. 6) option displays all defined friends group. An ‘AskFriends’ soft button 629 (FIG. 6) is used to create a screen for the preparation of the ad-hoc queries that can be communicated to friends in one or more groups. In general, an ad-hoc queries can be a simple text (such as a sentence typed in by the user), audio information recorded by the user, or even multimedia content assembled by the user. A “Record” soft button facilitates the audio recording on the mobile phone 121. A video clip or any other contents file can be attached to the ad-hoc query by an Attach 645 soft button (FIG. 6). The portal server 161 also facilitates management of friends lists employing equivalent screens, user interfaces, buttons, text entry boxes, selection lists, drop down boxes, etc.

In general, the user can compose a query and send it to the selected friends groups (can be sent to one group or more than one group) using a ‘Send’ 631 soft button. The members of the selected friends group receive the sent ad-hoc queries. Interested friends who are the members of the groups to which an ad-hoc query is sent, can respond to the ad-hoc query, replying back to the query sender, the response typically being collected before presentation to the sender. The answers or responses sent by a respondent to the query sender are, in general, a multimedia content comprising text, audio, and video clips. For example, the responses can be a combination of a selection from a multiple choice and an accompanying audio recording by the respondent. Those responses will be stored in the database 149 of FIG. 1 on the distribution server 141. The names, mobile phone numbers, e-mail addresses, user accounts, etc. that are used by a sender as a reference to the recipient in the associated friends group are often used as the search keywords or references/pointers into the friends list database 151. After a user sends a query to the members of a friends group, he selects the ‘Receive’ soft button 633 option (FIG. 6) in order to receive any answers/replies/responses on his mobile phone. (Similar features are provided by the portal server 161). In response to this all the answers currently collected are retrieved from the distribution server database for review by the user (who is often the sender of the query). The distribution server 141 essentially coordinates the caching and relaying of all the mobile phone messages that are composed in the client software (such as the Qello client) 123 in the mobile device.

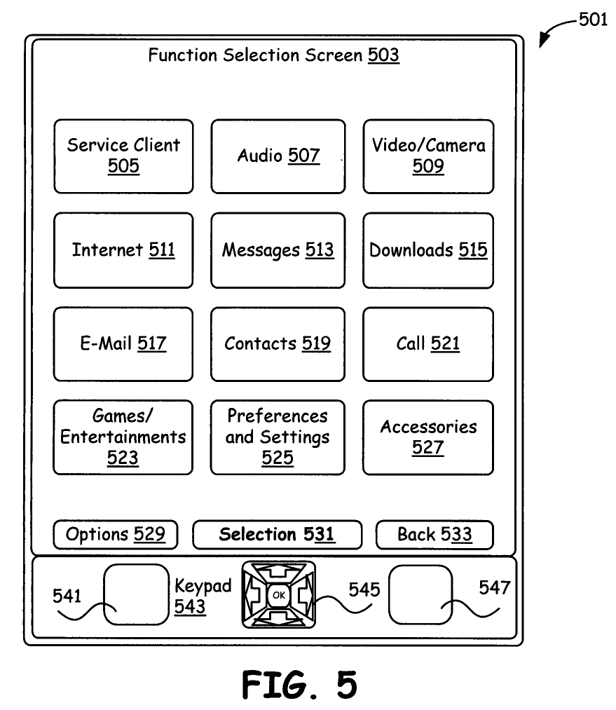

The received responses on the mobile phone are reviewed by the user. For example, audio responses received are played by the user by selecting the ‘Play’ soft button 635 (FIG. 6) option. The responses are played by simply selecting the user names/mobile phone numbers from the opened current friends group list. The joystick 545 (FIG. 5) on the mobile phone facilitates the browsing through the list of names of responders and their selection for audio playback from the currently open response list collected from a friends group. Upon selecting of the ‘Play’ button 635 option, typically, the associated APIs are invoked to play the response/answers. If the response is in the form of multimedia content whose content include textual, audio, video elements, the associated textual message is displayed while the audio element is played or the video element (if any) is played. For example, a pop-up window/new pane is opened where the response elements are displayed/played, wherein the responders answers (to a question for example) is displayed in the pop-up window/new pane (in FIG. 6).

Similarly an user composes ad-hoc queries from the client computer 105 and sends to a mobile phone 121 user. Again the contents sent are in the multimedia form, perhaps with a textual message, an audio query and a graphic included. Such client computer 105 to mobile phone 121 interactions for queries, questionnaires, interest indicator surveys, and interactive media communication, response creation and delivery are supported. A client computer to client computer interaction as well as a the mobile phone 121 to client computer 105 communication/interactions are supported. From the browser based client computer 105, an user can register with the portal server 161, generate an user account, provide a profile details that are stored in the database 149, and thus become a new member of the portal server for the services provided. The user can also become a member of the friends list database 151 as well as a member of a friends group.

When an user sends ad-hoc queries from client computer he/she makes optionally use of a special client software, that is similar to the client 123 in the mobile phone. Other wise, the user employs a web browser 107 available in the client computer 105 to interact with the portal server 161. In some embodiments, such interactions may employ client computer APIs or drivers and libraries provided by the client computer 105, for example to compose an ad-hoc query. The user can use an e-mail client for composing the queries and similarly he can receive collected or collated responses in the form of e-mails on the client computer 105. The contents of the e-mails will be of multimedia form with Audio/Video contents being attached to it, and an appropriate API might be employed to interact with a mail client in the client computer 105. Another API that assists a client computer user is a multimedia player and multimedia developer API typically available in the client computer 105 as DLLs or shared libraries. Furthermore, an SMS API, if employed will assist a client computer user to compose SMS messages to be delivered to the mobile phone users. Similarly SMS, or other forms of notifications from a mobile phone 121 will be received on the client computer 105.

The portal server 161 facilitates the interactions between a distribution server 141 and the client computer 105. It also provides a back up of database 149. In one embodiment, the data such as friends lists created by a user, and user profiles are synchronized between the distribution server 141 and portal server 161.

In another embodiment of the present invention the contents in an interactive media sent to recipient mobile devices and client computers go through a reformatting process or a transcoding process to better match device capabilities (the mobile phone capabilities or a client computer capabilities, etc.). This transcoding or reformatting is facilitated, for example, to suit the contents to the small screens on the mobile phones devices, that are heterogeneous, and are of different make and from a different manufacture than that of the sender's mobile phone or client computer.

In one embodiment, the service provided by the client in the mobile phone 121 (such as the Qello client from Vaudiofone, described in this present invention) in delivering the ad-hoc queries to the members of a selected friends group, that also collects and delivers the answers/responses, is called as the AskFriends service in accordance with the present invention. A similar AskFriends service is provided by the portal server 161. As the interaction is safe and secure and friendly among the registered members of the service, the ability to ask questions to friends/colleagues and receive immediate responses (that are collected/collated for ease of use) makes flexible and new mobile interactions possible. For example, new types of relates services can be created in an ad hoc manner using the AskFriends service.

The present invention makes it possible for any registrant on the database to subscribe to special services made available by some users (specific users may create new services as needed) by employing suitable menu selections, or activating appropriate option buttons during his interaction with the portal server 161. Such interactions and selections of new services is also possible using the client software 123 (an interaction of the user from the Qello client for example) in the mobile phone 121. Those special services can comprise obtaining information from the special databases for e.g. News, Realty, Entertainment, Health, etc. service databases.

One of the main advantages of the mobile web system of the present invention is the flexibility that a user is provided in defining his/her own friends group that is safe and secure for the exchange of information. Also, the delivery of ad-hoc queries and answers is instantaneous from mobile phone to mobile phone or from a mobile phone 121 to a plurality of other devices that may comprise other mobile phones, client computers, and user accounts in the portal server 161. The ad-hoc queries and answers are not lost on the network where the distribution server 141 and portal server 161 caches them, delivers them at later, when the mobile phone or the client computer are switched on. In one embodiment of the present invention, the caching time of the message can be set conveniently by the user during user account configuration. Multiple subscription levels are supported by the portal server 161 for the services it offers. For example, a special “premier” subscription facilitates larger storage and larger caching time, when compared to other free subscriptions that may be subject to advertisements.

The mobile web system 101 contains the distribution server 141, the mobile phone 121 with the client 123, a client computer 105, and the portal server 161 which are communicatively coupled using the network 103 in accordance with the present invention. The client 123 is optionally downloaded from the distribution server 141 and installed on the mobile phone 121. The client 123 has a registration coordination module 125, a user account coordination module 127 and an service coordination module 129 (such as an AskFriends service coordination module). The registration coordination module 125 is invoked by the selection of Register soft button 649 (FIG. 6) option from the client software screen 603 on the mobile phone 121. The registration coordination module 125 facilitates a new registration. If the user already has registered it prompts him for a login with the Login soft button 657 of FIG. 6 option which prompts user for his login ID and a password. After logging in, the user account coordination module 127 facilitates accounts configuration such that a user can subscribe for the special services etc.

The service coordination module 129 is a client module which coordinates data driven user interface screen generation and display, so as to provide the user the necessary screens with different option buttons on each screen. The mobile web browser 131 is an API which facilitates the mobile phone user for mobile phone internet services. The mobile phone APIs 133 comprises all the APIs which facilitates the functionality of the client 123. This includes the APIs for playing multimedia content (playing audio files, for example), for the generating the multimedia, the necessary editors, etc. The personal information manager (PIM) 135 is the module which manages the address book, bookmarks, history, and other personal details that are entered by the mobile phone user (owner). The PIM comprises contact information (such as phone numbers) for people who can be selected as recipients of a user generated query (such as an adhoc audio query). It can also comprise of names of recipient lists, wherein the recipient lists are stored, maintained, and managed by the distribution server 141 or the portal server 161.

The client computer 105 makes it possible for the client computer user to the access the services provided by the portal server 161. Such services may employ the distribution and response collection facilities provided by the distribution server 141.

In one embodiment, the AskFriends service wherein the user can create and send a query (or an interactive media) to one or more lists of recipients, and receive collected responses subsequently, is accessed by the user of the client computer 105 webpages provided by the portal server 161 that are displayed by the web browser 107. For example, the client computer user needs to start the web browser 107 and type in an appropriate URL (such as the one for AskFriends portal server 161) to retrieve/display a registration page that asks the user to first Login. By registering and creating an account, the user can access the services. If the user already has an account, the user starts by logging in. The user can create a new user account webpage 111 or edit one that exists, if necessary. The account setting configurations helps to customize the user account. Accounts previously created via the mobile phone 121 can be edited using the client computer 105.

The client computer user browses a service related webpage 113 to create new interactive media, review responses received, respond to queries from other friends, manage friends lists, etc. The services related webpage 113 (and other related webpages) can be accessed from the user account webpage 111 if necessary, and it helps a user perform all the operations that are possible from mobile phone using the client 123 (such as the features provided by the Qello client provided by Vaudiofone for example). The typical operations comprise composing ad-hoc queries, sending them to the friends group members, receiving responses/answers from the members of the friends group, reviewing the responses received and playing audio/video in the individual responses, threading new discussions based on the responses received, sending follow-up queries to one or more of the respondents, etc.

The operation of the distribution server 161 further comprises sending SMS notifications regarding incoming queries or interactive media to client 123 in mobile device 121, sending e-mails containing the URLs of a response page hosted by the portal server 161 and an URL to a downloadable client software 123 to recipients who are not yet registered members for the service, etc. For example, emails sent to recipients (whose email address is known and is part of a list of recipients for a query or interactive media) comprise of a link to the downloadable client software with a prompt asking the recipients to download the client onto their mobile devices. Such emails also comprise a link to a webpage hosted by the portal server that lets the recipients register for the service, and a URL for a webpage that facilitates responding to the current query/interactive media.

Typically, a registered user creates multiple list of recipients, and calls them with unique names such as ‘Friends’, ‘Colleagues’, ‘Artists’, ‘Architects’, etc., each one them being user defined groups. Each of those lists comprises contact information of other registered members or of friends who are not yet registered members. Some of these recipients may have a particular relation to the registered member/user, share a particular interest with him or display some expertise. Those members of the groups with the particular expertise may be consultants whose interaction requires subscription for a special service. In addition, the portal server 161 can additional list names, such as a ‘Facebook friends’ and a ‘Myspace list’ for providing a reference to externally maintained lists of recipients (such as those maintained by external social networking websites).

The audio recording webpage 115 facilitates recording of an audio query by a user that can be supplemented with textual inputs, a multiple choice set and an optional graphics. The user is presented buttons for recording audio, replaying them and storing them. For example, by invoking the audio recording buttons and b speaking into a microphone attached, a user can record an audio input. Additionally, prerecorded audio files can be retrieved and incorporated into a query or interactive media being created by a user. Pre-recorded audio files can be retrieved in a compatible format that could be played on the mobile phone or on other client computers. Content delivery using audio inputs wherein the client software 123 in the recipient mobile devices is able to play such audio inputs, with the recipients also being able to respond in an audio or video form, without having to use the keyboards at all (or with just limited use of a joy-stick or soft key) is another major advantage of the present invention.

The client APIs 119 in the client computer 105 provides a set of APIs that run on the computer, with access to device drivers and libraries available on the client computer. They facilitate creating and playing of multimedia form of content, such as audio and video information, as well developing messages in the form of multimedia elements. For example, the APIs include device drivers for the web camera, recorders, loudspeaker, etc, devices. The set of APIs 119 also contains APIs for an SMS client, e-mail clients etc. which complements the functionality of the client 123 typically used in the mobile phone 121.

The distribution server 141 comprises a server APIs 143, a registration manager 145, a server backup module 147 and a database 149. The server API 143 comprises a set of APIs that perform the content delivery functionality incorporating the mobile phone 121 device capability and make and manufacture information. These APIs are used to retrieve the mobile phone information from data received from the mobile phone or from pre-registered information, such data and pre-registered information being employed to retrieve device specific configuration and capability information hat aid in optionally transcoding/modifying/reformatting the queries and multimedia content (audio, graphics, video, etc.). In some embodiments, no such transcoding or modification is necessary. The friend list database 151 of the 149 with a copy of recent message stored in 151.

A registration manager 145 in the distribution server 141 is associated with the registration coordination module 125 in the mobile phone 121 and the registration webpage 109 provided to the user of the client computer 105. It facilitates storing new registration information and in retrieving them for subsequent editing, access control and management. It also coordinates registered account confirmation and it facilitates configuration by an interaction with the ‘user account coordination module’ 127 of the mobile phone 121 and ‘user account webpage’ 111 accessed using the ‘client computer’ 105. A ‘server backup module’ 147 facilitates synchronization of the distribution server 141 and the portal server 161 databases. Such synchronization can be in active mode wherein records are synchronized as soon as they are modified or created on any one of the distribution server 141 and the portal server 161, or in a lazy mode.

The database 149 comprises all the databases such as a friends list database 151, an account database 153, a webpage cache 155 and an external service provider database 157. The friends list database 151 has a list of all the members of the friends group as well as the list of names of individual registrants. Basically this list contains the member's name, mobile phone numbers, with e-mail addresses, etc. which acts as search keyword for searches and also as pointers/keys into the account database 153.

The friends list database 151 comprises names of the individuals and the lists they are referred in (the friends groups names, for e.g. Friends, Colleagues, Artists, Architects, etc. ). When a user using the mobile phone 121 or the client computer 105 selects or refers to those friends names or the names of the friend groups (also called list of recipients sometimes), the associated details (contact information) are retrieved and used as needed, such as for distributing a query. If the selected name is associated with a registered member, the account details (such as name, photo, mobile phone numbers, e-mail address) are retrieved from the friends list database 151 are displayed to the user on his/her mobile phone 121 or client computer 105.

The accounts database 153 contains all account details, settings and configurations for registered members. The webpage cache 155 contains all the threaded messages of the recent discussions that will be cached for specified default duration of time. This provides for a better performance and also for better end user experience.

The external service provider database 157 contains the details of other external systems/portals/service providers from whom a user can subscribe for special services such as News agencies, Entertainment providers, Realty info, Health care services, etc. It also presents an interface to external systems that may be used to retrieve data from such external service providers. For example, it provides an interface to retrieve a registered users friends lists hat may have been created with an external social networking website such as Facebook and Myspace.

The portal server 161 comprises a web portal server APIs 163, a web portal registration manager 165, a web portal backup module 167, and a web portal database 177. The portal server 161 facilitates registration operations and the friends group interaction from the client computer 105. The interactions, such as sending queries and receiving collected responses may be from the client computer 105 to another group of client computers and from the client computer 105 to one or more mobile phones (similar to the mobile phone 121) via the network 103.

The ‘web portal server APIs’ 163 are a set of APIs which perform the contents delivery functionality depending on the mobile phone 121 and client computer 105 capabilities and their make and manufacture. These APIs retrieve the mobile phones make and model information from an internal library and selects an appropriate style file for reformatting the multimedia contents that are routed via the ‘web portal friends list database’ 169 with a copy recent message stored in the ‘web portal webpage cache’ 173.

The web portal registration manager 165 coordinates registration by providing a registration webpage 109 to the client computer 105, that can be used by a new user to register and become a member, and to retrieve registration information for review and optional editing. It also coordinates in registered account setting and configurations through an interaction with the ‘user account webpage’ 111 of the client computer 105. The ‘web portal back up module’ 167 facilitates the synchronization of the distribution server 141 and portal server 161 databases.

The web portal database 177 comprises all the databases such as a web portal friend list database 169, a web portal account database 171, a web portal webpage cache 173. A web portal external service provider database 175 makes it possible to interact with external service provider databases, such as those maintained by an operator or by an external social networking website. The web portal friends list database 169 maintains a list of names of all the members of the friends groups as well as the names of each registrants on the distribution server and portal server databases. Basically this list contains the member's name, mobile phone numbers, e-mail addresses, etc. Some of this information can be used as search keywords and pointers/keys into the web portal account database 171.

The list 169 maybe names of the individuals or friend group names for e.g. friends, Colleagues, Artists, Architects, etc. when a user from a mobile phone 121 or client computer 105 types in those names or group names the account details such as name, photo, mobile phone numbers, and E-mail of the registered members are displayed to the user on mobile phone 121 or the client computer 105.

The web portal account database 171 comprises account details and account settings and configurations that a user has provided, and has access to upon logging into the portal server 161. The web portal webpage cache 173 contains all the threaded messages of recent discussions that are cached. Such caching can be for a specified default duration of time. Special subscriptions to the service may have extra privileges to configure or manage the caching behavior, such as by managing the cached duration, the amount of storage, etc.

The web portal external service database 175 also contains the details of some service providers from whom a user can subscribe for special services such as ‘News agencies’, ‘Entertainment providers’, ‘Realty info’, ‘Health care services’, etc.

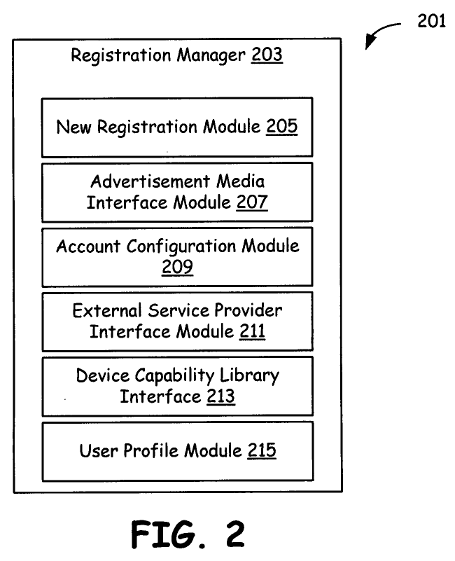

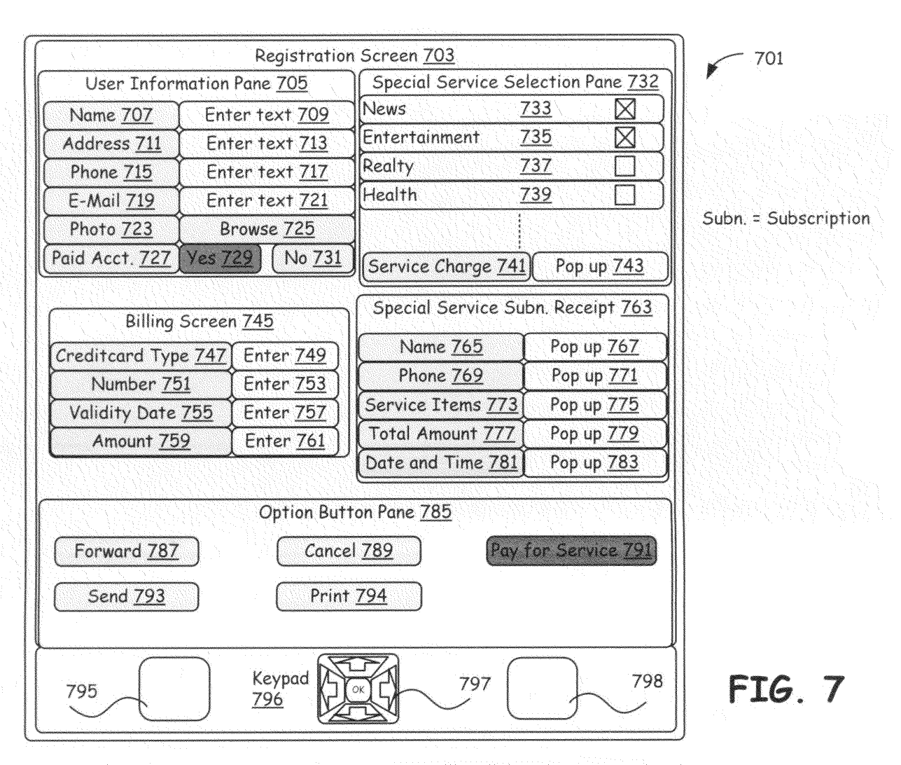

FIG. 2 is a block diagram showing exemplary components of a ‘registration manager’ employed by the distribution server 141 in accordance with the present invention. The registration manager 203 manages the new registration functionality. It comprises a new registration module 205, an advertisement media interface module 207, an account configuration module 209, an external service provider interface module 211, a device capability library 213 and an user profile module 215. The new registration module 205, is invoked by the user by selecting a ‘Register’ softkey/button 655 (or an appropriate user interface element provided). The selection of the ‘Register’ softkey/button opens a registration screen 703 that is described later in of FIG. 7, on the mobile phone 121. By furnishing the essential information prompted, the user is provided an account—such an account can be created, for example, from the client 123 software in the mobile device 121 or even (in some embodiments) using the web browser 107 and webpages 109 on the client computer 105. The account thus created enables a user to use the portal server 161 and access the service, as well as use the mobile device 121 and access the same/similar service.

The advertisement media interface module 207 sets user specified attributes or default attributes (that are based on account type, for example) to the user accounts automatically differentiating a free account from a special or premier account. For example, for a free account, ads are posted and the user has no control over filtering the ads. For a special or premier account, the user has an option to customize the ads flow into his/her account (i.e. the user gets to view the type of ads he desires).

The account configuration module 209 provides the options to configure the user accounts. For example, a user can modify the appearances of the login window, make a choice of textual editors (choose from a plurality of editors available), make choice of fonts, font size, etc. The options/preferences/selections made by the user are saved so that they are available in the subsequent login session(s). The configuration settings are incorporated and saved—for example, configurations made on the mobile phone 121 are saved and reused/loaded if the user logs-in subsequently from the client computer 105, and vice versa.

The external service provider interface module 211 is responsible for prompting the user to select a friends list maintained by an external service provider or an external social networking website. For example, an updated list of friends list is retrieved and presented to the user (as yet another list available for selection, for example) each time the user logs-in from either the mobile phone 121 or the client computer 105. In addition, access to services made available by external service providers, to which the user has access or has a subscription, are provided by this interface. Thus the module 211 also facilitates the external service subscription with each of the service providers and information on the validity of the subscription. It alerts the subscription expiry by sending SMS or E-mail to the user or by providing a popup/warning message as needed.

The device capability library interface 213 manages device capability information, formatting needs for different types of content for the different platforms and types of mobile devices, etc. It helps in the formatting of the multimedia content, as necessary, and trims messages, as necessary, as they are delivered to mobile phones of the different make and manufacture. This library holds the device capability information on all the models of mobile phones that are available in the market or used by a company. In one embodiment, it makes available a suitable style sheet or transcoding file for the model of mobile phone that a user is using currently.

The user profile module 215 holds all the user profile information which a user has furnished during registration. It comprises all the information about a user, such as his name, photo, mobile phone numbers, e-mail address, and other information such as the those friends groups in which his name is included. Those friends groups are typically those created and managed by other users who are registered users.

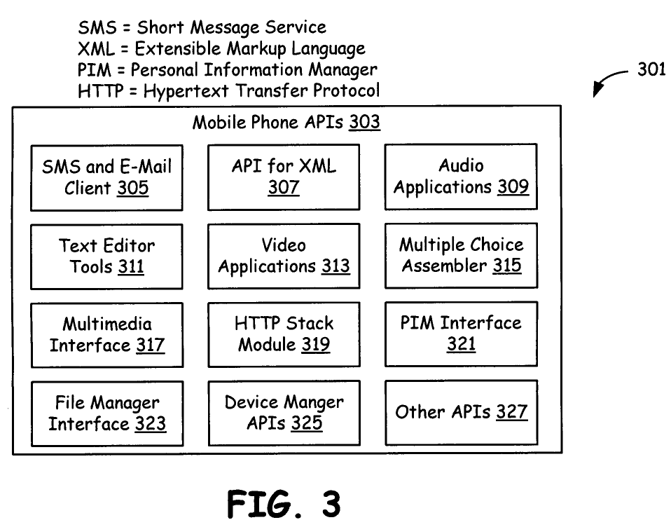

FIG. 3 is a block diagram of an exemplary mobile phone API built in accordance with the present invention. The mobile phone APIs 303 support the various features that are typically implemented ( based on the various client side functionality described) in the client 123 of FIG. 1. This set of APIs is provided in the mobile phone 121 by default, and may reside on a mobile phone memory. Alternatively, the APIs and associated components are downloaded from the distribution server 141.

The set of mobile phone APIs 303 comprises an SMS and e-mail clients interface 305, an API for XML 307, an audio application 309, a text editor tools 311, a video applications interface 313, a multiple choice assembler 315, a multimedia interface 317, a HTTP stack module 319, a PIM interface 321, a file manager interface 323, a device manager interface 325, and an other APIs 327 set of miscellaneous APIs.

The SMS and the E-mail client interface 305 interacts with the client 123 of FIG. 1. SMS and E-mail services are accessible, and SMS and email can be sent and received. E-mailing is possible if the user has a valid E-mail account. SMS and E-mails can be received and displayed on the mobile phone 121, just as it is supported on the client computer 105. The API for XML 307 facilitates XML code execution on the mobile phone 121 i.e. the execution of the embedded XML code which is received from a remote server. It also facilitates data driven screen generation, wherein the type of user interface screens, and the content therein is determined by the data provided in an XML document received by the client 123 from the distribution server 141. If the XML document comprises a URL, such as an URL for an audio file, the API for XML 307 helps retrieve the URL for retrieval and playback of the audio file.

The audio interface 309 comprise those APIs that facilitate playing of the audio messages, voice recording, storing, replay, formatting, etc. The text editor interface 311 comprise APIs for editing textual contents. The video interface 313 comprises APIs for playing video content, such as streaming media, movies, animated images, etc.

The multiple choice assembler 315 provides APIs that assemble multiple choice selections from data delivered by the distribution server, such as XML document with multiple choice selection information. For example, it makes it possible to assemble a multiple choice selection by retrieving multiple choice elements from an XML questionnaire. Thus, the simplest form of questionnaire can be delivered to group of members by the distribution server 141 with responses prompted in the form of multiple choice options and responses received in the form of the user selections of multiple choice options.

The multimedia interface 317 provides APIs that can be used to display multimedia content. They can also be used for animation, imaging and as movie creation tools. The HTTP stack module 319 provides APIs that may be used to handle HTTP protocol based communications. It is used to receive and deliver contents on the mobile phone devices using the HTTP protocol. The PIM interface 321 provides support for retrieving contact information, retrieving list of recipients, etc. when the user wants to send a query to one or more recipients. It facilitates gathering and storing important personal/contact information of one or more recipients.

The file manager interface 323 provides APIs that facilitate storage of content, XML documents, voice recording etc. in the file system of the mobile phone 121. It supports automatically managing the files that are created. For example, when an image/picture/snapshot is taken on the mobile phone 121, it can be stored using the file manager interface. A default file name (dynamically created) can be generated when needed.

The device manager APIs 325 comprises device drivers. For example, the device manager APIs support interactions with a headset and with a Bluetooth based detached display. The other APIs 327 support miscellaneous functions and utilities, such as those that interact with other subscribed services, those that provide device dependent capabilities on the mobile phone 121, etc.

The modules that are discussed with respect to mobile phone APIs often have their counter parts on the client computer 105 to realize similar/compatible feature or functionality from the client computer 105.

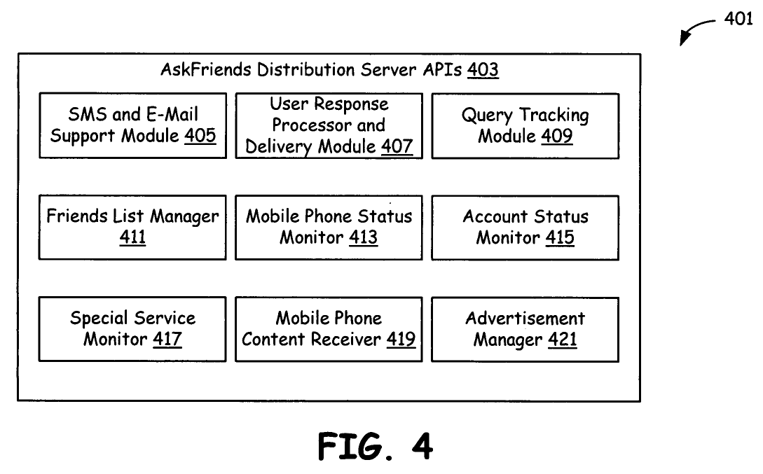

FIG. 4 is a block diagram with exemplary components of a distribution server APIs in accordance with the present invention. The distribution server APIs 403 complements the functionality of the ‘mobile phone APIs’ 133 of FIG. 1 (discussed more in detail in the FIG. 3) for functional implementation of the client 123 of FIG. 1. It comprises a SMS and E-mail support module 405, a user response processor, a delivery module 407, a query tracking module 409, a friends list manager 411, a mobile phone status monitor 413, an account status monitor 415, a special service monitor 417, a mobile phone contents receiver 419, and an advertisement manager 421.

The SMS and the E-mail support module 405 supports communicating the SMS and e-mails that are sent from the mobile phone 121 and the client computer 105 of FIG. 1. The user response processor and delivery manager 407 collects, optionally collates and sorts the response′/answers that are sent by the friends group members. It prepares them to be delivered to the mobile phone 121 or accessed by the user using the client computer 105 and the portal server 161, such as when the user selects the ‘Receive’ button 633 option of FIG. 6.

The query tracking module 409 tracks the status of the query. If the query is not immediately delivered for some reason, the ‘query tracking module’ 409 keeps periodically trying to deliver the same query to those mobile phone or client computer to whom it failed to deliver in previous attempts. This repeated attempt of query delivery is continued for a predefined period of time. If the query is still not delivered at the end of that predefined period further attempts of delivery are dropped and appropriate alerts are optionally sent to the sender.

The friends list manager 411 manages all the registered users so that the searching through names, phone numbers or e-mails is conducted easily. This feature is helpful in the formation of new friends groups by the user, because it facilitates searching friends by name or other details, and helps incorporating them into the new group. The mobile phone status monitor 413 acquires the status of the mobile phone from the mobile network, such as whether a mobile phone is switched ON or OFF, whether it is out of network coverage area, etc. The account status monitor 415 keeps track of account access, account changes, subscription periods, etc. It sends alerts for renewal on the verge of expiry of a user's subscriptions.

The special service monitor 417 facilitates the special service details monitoring functionality. This module summarizes the special service subscription details of each account and maintains that summary against each account. This information will be useful for administration. The mobile phone contents receiver 419 facilitates the gathering of queries and responses of all the types. This module has the contents reformatting capability to suit the targeted mobile phone. It collects responses and optionally collates them prior to display/delivery to a user. The advertisement manager 421 keeps track of ads delivery to free accounts and selective delivery to special subscription accounts. Special subscription accounts filters ads based on the choice of setting made by the account owner/user.

The modules that are discussed with respect to distribution APIs 403 have their counterpart associated with the web portal server APIs 163 of FIG. 1.

FIG. 5 is an exemplary snapshot of a function selection screen of the mobile phone with client software in accordance with the present invention. The function selection screen 503 comprises the icons list from 505-527 whose selection will accomplish the corresponding functionality. All the installed software tools provide interfaces to the users in the form of icons on this screen. This screen has icons such as ‘Qello client’ icon 505, an audio icon 507, a Video/Camera (Image) 509 icon, an Internet icon 511, a Messages icon 513, a Downloads icon 515, an E-mail icon 517, a Contact (book) icon 519, a Call icon 521, a Games/Entertainments icon 523, a Preferences and Settings icon 525, and an Accessories icon 527.

When the user select the service client icon 505 the ‘Qello client’ will be started on new Qello screen 603 of FIG. 6. In one embodiment, the label service client is replaced by a name of a client software, such as ‘Qello”. The audio icon 507, when activated, invokes audio functions, such as those that are used to play audio and those used to record audio inputs from a user. The Video/Camera icon 509 starts video playback/recording, digital photo capture or imaging functionalities.

The Internet icon 511 facilitates the internet browsing by opening, for example, a mobile web browser. The Messages icon 513 is used to send an SMS message to other mobile phones and client computers. In one embodiment, it is used to send a canned message (pre-recorded) to one or more recipients using the distribution server, wherein the canned message (which may be pre recorded by the user or provided by the service) is either stored and sent from the mobile phone 121 or retrieved from the portal server 161 or the distribution server 141. In this embodiment, the service client is transparently used for sending a message.

The Downloads icon 515 supports download of interactive content from the distribution server, wherein the downloaded content is handled/processed by the service client 505 (such as the Qello client). For example, the interactive media may be tagged with an appropriate MIME type and the service client 505 is invoked for content with those MIME types that the service client 505 is registered to (and is capable of) handle. In one embodiment, Downloads icon 515 provides a shortcut through which a mobile web browser is started and prompts the user to enter URL of the download site for downloading the contents.

The e-mail icon 517 starts an e-mail client on the mobile phone prompting the user to login into his e-mail account for sending and receiving the e-mails. The Contacts icon 519 is the user interface to the ‘PIM’ 135 of FIG. 1, which facilitates managing the contact list available in the mobile phone 121. The contacts managed in the PIM comprises individual entries for friends/colleagues, etc. and also names of groups of friends, wherein the membership (individual contact information for the members of the group) details are remotely available at the distribution server 141 or the portal server 161 or at both laces (or even at an external service provider website, etc.).

The Call icon 521 facilitates dialing to make a phone call. For example, a user is prompted to dial a mobile a phone number initiate a call. In one embodiment, when a call is made, a prerecorded audio message created using the service client is played so as to communicate audio information to the called recipient. In a related embodiment, when the call icon 521 is activated, a pre-recorded video message (recorded and stored using the service client 505) is played and communicated to the called phone number. In a different embodiment, when a user makes a call using the call icon 521 (such as a VOIP call, for example), the responses provided by the user to one or more queries/questionnaires are communicated to the called entity (which could be associated with the distribution server or some other server).

The Games/Entertainments icon 523 opens a list games and entertainment choices currently available/accessible and provides an interface with the entertainment modules for e.g. access to a radio, etc. on the mobile phone 121. Users can play games and listen to music, etc. the service provided by third party. The Preferences and Settings icon 525 facilitates an interface for the configuration of the mobile phone 121 in terms of its appearance and performance. The accessories icon 527 provides an interface to miscellaneous functionalities such as calculator, calendar, etc.

The function selection screen 503 also comprises some soft keys/buttons such as an ‘Option’ soft key 529, a ‘Selection’ soft key 531, and a ‘Back’ 533 soft key. The default action is the ‘Selection’ 531 button on this screen (i.e. the function selection screen) of the highlighted icon when the OK button is hit on the ‘joystick’ 545 from the keypad 543.

Activating the 541 key from the keypad 543 will open the Options 529 functionality, which results in presenting the user with a list in a menu or sub-menu, which can be browsed using the ‘joystick’ 545. The ‘Back’ soft key/button 533 will be selected when the key 547 is activated on the keypad 543, to cancel the current screen to go back to the previous one.

FIG. 6 is an exemplary screen snapshot 601 of a mobile phone depicting the review of the responses (to queries, questionnaires, interactive media, etc.) received from the members of one or more friends groups, in accordance with the present invention. When the user selects the service icon 505 of FIG. 5 the service screen 603 of FIG. 6 is presented to the user. From service screen 603 the user can register with the distribution server 141 of FIG. 1 for availing the (query/questionnaire distribution and response collection) services. For example, the services help the mobile phone user to send ad-hoc queries to one or more friends groups (each group comprising one or more recipients) and to receive responses/answers from the members of the friends groups. Each response may comprise of a textual response, an audio response, a video response, a multiple choice selection, or a combination of these. Thus, when a user selects an individual response from a list of responses for a given query/question, the various types of responses provided by the user are shown in different panes (for example in juxtaposed windows/panes/frames).

The mobile phone user can also configure his/her service client 123 (such as Qello client from Vaudiofone) of FIG. 1 for special services from this screen. The configuration comprises, for example, the mode of security/encryption employed, the number of minutes after which the first set of responses are provided, the number of days after which the query/questionnaire/interactive media expires (for recipients who do not respond in time or do not reply back at all), etc.

The options that are available to the mobile phone user from this screen are indicated as soft keys/buttons such as ‘AskFriends’ softkey/button 629, ‘Send’ softkey/button 631, ‘Receive’ softkey/button 633, ‘Play’ softkey/button 635, ‘Save’ softkey/button 637, ‘Reply’ softkey/button 639, ‘Forward’ softkey/button 641, ‘Record’ softkey/button 643, ‘Attach’ softkey/button 645, ‘Group select” softkey/button 647, ‘Register’ softkey/button 649, ‘Print’ softkey/button 651, ‘Multiple choice’ softkey/button 653, ‘New group’ softkey/button 655, ‘Login’ softkey/button 657, and the ‘Quit’ softkey/button 659.

The ‘Login’ button 657 facilitates the user to login into his/her service account. Login is not needed for every access, in one embodiment. Instead, login is needed only if the data/content indicates that the user needs to be authenticated. Otherwise, the user has access to the services without login by default. In a different embodiment, login is mandatory for all types of access/services. After logging in, the user can perform all the operations for which he/she is entitled.

If the user selects the ‘AskFriends’ button 629 option he/she can compose a query/question/questionnaire/interactive media and distribute it to one or morel lists/groups of friends to receive responses. For example, the user can create ad-hoc queries and send them to the members of the selected friends group from the friends group 605 pane containing a list such as ‘Friends’ 607, ‘Colleagues’ 609, ‘Artists’ 611, ‘Architects’ 613, etc. Each query is routed to the ‘AskFriends’ account of each recipient, to a mobile phone, to a user account on the portal server 161, to an IP address, as well as to their E-mail accounts, as appropriate. Sending a query takes place when the user selects the ‘Send’ softkey/button 631 option from the ‘Option button pane’ 627.

The ‘Receive’ button 633 is selected to download all the messages have arrived into a registered user's account. In one embodiment, the messages comprise of responses received, queries received from other users to which a response has to be provided, request to approve inclusion in a fiends list being created by a different user, etc. The messages can be sorted by categories or sorted by date/time on the mobile phone 121 of FIG. 1 in the ‘Query and Response list pane’ 615. In one embodiment, the responses received are identified by the recipient's name and mobile phone number pairs 617, 619, 621. If the recipient does not have a mobile phone number, their account name, email address or associated reference information is displayed along with the name.

The user browses through the list of responses in the Query and Response list pane’ 615 using the ‘joystick’ 675. Upon browsing through the list to a particular item of the downloaded messages, the user selects the ‘Play’ button 635 option. When the user selects a name from 615, the latest uploaded photo of the Query/Answer sender will appear in the ‘picture pane’ 623. This ensures the security and guarantees that the sender is a known person or a friend. If the received message has any still images or a movies clips it is played in a separate ‘Video pane’ 625. Textual messages are displayed in a textual content display pane 681 while selections from a multiple choice set of answers are displayed in a multiple choice display pane 683.

When the user browses through the list of queries that have to be responded to, the Query and Response list pane’ 615 lists the available queries and the user selects a query/questionnaire/interactive media using the ‘joystick’ 675. Upon browsing through the list to a particular item of the downloaded/available queries/questionnaires/interactive media, the user selects the ‘Play’ button 635 option. When the user selects an item from the list in pane 615, the latest uploaded photo of the person sending the query/questionnaire/interactive media (the sender) appears in the ‘picture pane’ 623. This ensures the security and guarantees that the sender is a known person or a friend. If the received query has any still images or a movies clips it is played in a separate ‘Video pane’ 625. Audio content is played on selection of the query/questionnaire, etc. Textual messages are displayed in a textual content display pane 681 while a multiple choices are displayed in a multiple choice display pane 683.

The ‘Save’ button 637 option saves a message in a default directory. The ‘Reply’ button 639 option prompts the user to enter reply/response to a message/query. The ‘Forward’ button 641 options prompts the user for a contact information to which the current message, query or response is to be forwarded. For example, the user can provide a mobile phone number, select an entry from the contact lists maintained in the PIM, etc. to forward a message to one or more mobile phones, to one or more user accounts in the portal server, or to one or more client computer users. The ‘record’ button 643 option prompts the user to create a multimedia (comprising text, audio/video, etc.) contents that can be captured and sent to one or more recipients.

The ‘Attach’ button 645 option prompts the user to attach images, text, videos, etc. from their default directories or from specific directories/storage. The ‘Group select’ button 647 option opens groups (friends lists, etc.) that are already defined by the user, in the 605 pane. The ‘Register’ button 649 option prompts the user with a ‘registration screen’ 703 of FIG. 7 for a new registration. The ‘Print’ button 651 option prints the current screen contents on a printer in proximity, such as a Bluetooth printer. In one embodiment, it supports printing onto a remote printer across the Internet.

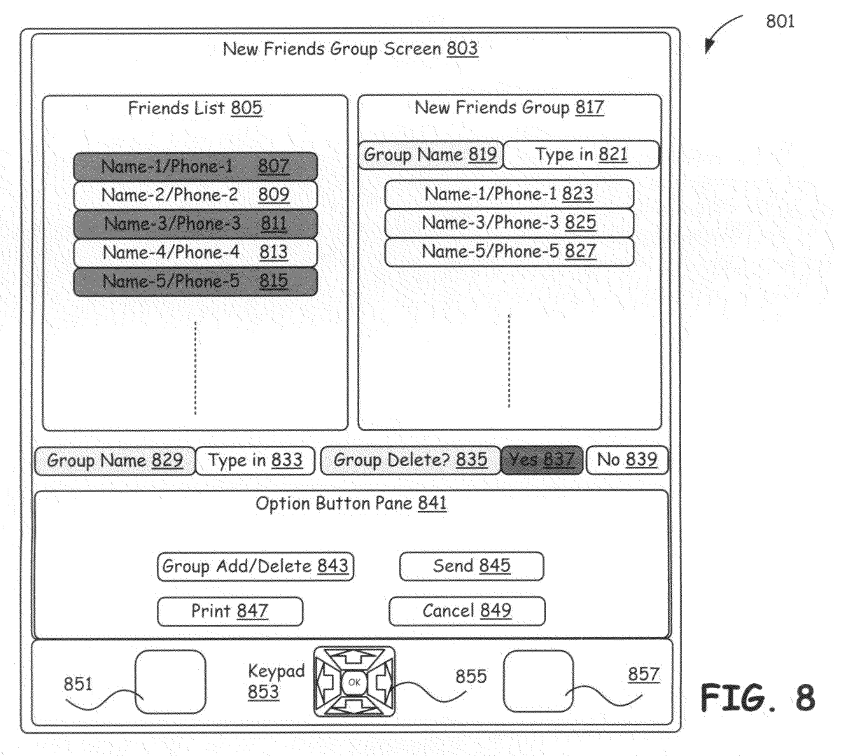

The ‘multiple choice’ button 653 option prompts the user to compose multiple choice entries for ad-hoc queries and questionnaires, such as those with selectable radio buttons, to send to a selected friends group, wherein the friends groups are listed and selectable in the Friends group pane 605. This option facilitates the statistics gathering on certain subjects too. The ‘New group’ button 655 option prompts the user to define a new friends group by opening a “new friends group screen’ 803 of FIG. 8. The ‘Login’ button 657 option facilitates login by the user into his service account. The ‘Quit’ button 659 option quits the service client.

The ‘keypad’ 673 is the repetition of the ‘keypad’ 543 of FIG. 5 with each keys viz. 671, 675, and 677 being the same as keys 541, 545, and 547 respectively, functionally.

FIG. 7 is a Registration screen snapshot of a mobile phone presented to the user during registration on a distribution server, in accordance with the present invention. The registration screen 703 opens in response to the selection of the ‘Register’ button 649 option from the screen described in FIG. 6. The ‘registration screen’ 703 contains a ‘User information pane’ 705, which provides some textual entry fields with prompts such as ‘Enter Text’. In such fields 709, 713, 717, and 721 the user can enter appropriate registration information, as suggested by the associated labels—‘Name’ 707, ‘Address’ 711, ‘Phone’ Number 715, ‘E-mail’ 719. The ‘Photo’ item 723 prompts the user to browse to upload his/her photo using the ‘Browse’ button 725. The ‘Paid Acct.’ item 727 prompts the user to select one of two account options, a free account or a paid account. The user can select a paid account using the options ‘Yes’ 729, or opt for a free account using the option ‘No’ 731.

If the user selects ‘No’ 731 option the registration is completed with the resulting account being free. If the option ‘Yes’ button 729 is selected a ‘Special Service Selection pane’ 732 opens. The 732 screen has a list of special services for e.g. ‘News’ 733 option, ‘Entertainment’ 735 option, ‘Realty’ 737 option, ‘Health’ 739 options, etc. against each of them with a radio button. The list can be browsed and selected by a ‘joystick’ 797 (545 of FIG. 5 repeated). The selection of an item is marked with a cross symbol on the radio button. At each selection the ‘service charge’ 741 item is updated in the ‘pop up’ 743 field.

After ensuring that the service/subscription charges from the 743 field is correct, the user can initiate payment by the selection of the ‘Pay for Service’ button 791 option or can deselect unwanted services using the ‘Cancel’ button 789 option.

If the user selects the option 791, the ‘Billing screen’ 745 pops up with text input prompts ‘Enter’ displayed in textboxes 749, 753, 757 761 for billing data items labeled ‘Credit card type’ 747, ‘Name’ 751, ‘Validation date’ 755, and ‘Amount’ 759. For each of these items the user types in the appropriate field next to these items with the relevant information. After filling the details in the ‘billing screen’ 745 the user selects the ‘Send’ button 793 option. In response to the send option the ‘Special Service Subscription Receipt’ 763 is opened. The ‘Special Service Subscription Receipt’ 763 has all the relevant objects/items such as ‘Name’ 765 of the subscriber, ‘Phone’ number 769 of the subscriber, ‘Service Items’ 773 selected from 732 screen, ‘Total amount’ is the service charges that pops up in the 743 of the 732 screen or that entered by the user in the 761 field of 745 screen and the ‘date and time’ 781 of service subscription. The relevant parameters/values for these objects pops up in the fields 767, 771, 775, 779 and 783 respectively. The user can print this receipt 763 using the ‘Print’ button 794 option on a Bluetooth printer.

The ‘forward’ button 787 option enables the user to forward information from any of these screens to any other mobile phones of his/her friends. The ‘Keypad’ 796 is the same as the ‘keypad’ 543 of FIG. 5. The keys 795, 797, and 798 selections perform the function of keys 541, 545, and 547 respectively of FIG. 5.

FIG. 8 is an exemplary snapshot of a ‘New friends group’ creation screen in a mobile phone used by a user to create a new group comprising a list of references to friends, the new friends group being stored on a distribution server in accordance with the present invention. The ‘New Friends group screen’ 803 is provided to the user, for example, in response to the selection of the ‘New group’ button 655 option of FIG. 6. Through this screen the user is presented with the ‘friends list’ 805, which is a list of cntacts extracted from the user's PIM (for example) or from an external source (such as an external contact database). In one embodiment, the ‘friends list’ 805 contains the list of all the members' names who have registered on the ‘distribution server’ 141, or a subset thereof (such as all members whose name starts with an ‘A’, or all members who live in Laguna Niguel or attend a particular college, etc.). The list appears by default in the alphabetical order of the names with Name/Phone number pair, for e.g. Name-1/Phone-1 807, Name-2/Phone-2 809, etc. in the ‘friends list’ 805. The user can select one or more items presented in the friends list 805 (selecting contact information for one or more individuals). The user uses the ‘Group add/delete’ button 843 option to create a ‘New group’. In response to the selection of the button 843 ‘New friends group’ 817 window (or pane) pops up. It has a ‘group name’ 819 prompt to which the user can provide a name by typing into the field 821 next to the label. The user can type in the group name, for example, entering the text ‘Friends’ (see for e.g. 607 of FIG. 6). By subsequently selecting one or more items (or additional items) from the friends list 805, the user can assemble contact information into the new friends group 817. Thus, by selecting the name/phone entries 807, 811, 815 from the ‘friends list’ 805 the user has them entered into the ‘new friends group’ 817. For example, ‘Name-1/Phone-1’ 823 is the ‘Name-1/Phone-1’ 807 selection, ‘Name-3/Phone-3’ 825 is the ‘Name-3/phone-3” 811 selection, and so on.

On the other hand, if the user wants to delete an existing friends group the user can again hit (select) ‘Group Add/Delete’ button 843 option. An additional set of options buttons pops up such as ‘Group name’ 829 associated with ‘type in’ field 833, and ‘Group delete?’ 835 associated with ‘Yes’ button 837 option and ‘No’ button 839 option. In the ‘type in’ field 833 the user types in the group name to delete an unwanted friends group. The group delete confirmation can be done by selecting the ‘Yes’ button 837 otherwise ‘No’ button 839 to cancel the delete operation. In a different embodiment, when the user selects the Group Add/Delete button 843, a list f existing groups is presented in place of the Friends list 805 wherein each entry in the list is a name of a group. The user can select one or more group names from the list and activate the Group Delete button 835 to delete the selected groups. Other types of user interaction screens are also contemplated.

The ‘Send’ 845 button option selection updates the ‘distribution server’ database with a ‘New group’ defined by the user. The ‘Print’ button 847 option selection prints the current screen on a Bluetooth printer. A ‘cancel’ button 849 option selection cancels the current operation of new group definition and reverts to the previous screen.

The keypad 853 is the same as the keypad 543 of FIG. 5 with each keys viz. 851, 855, and 857 being the same as 541, 545 and 547 keys respectively.

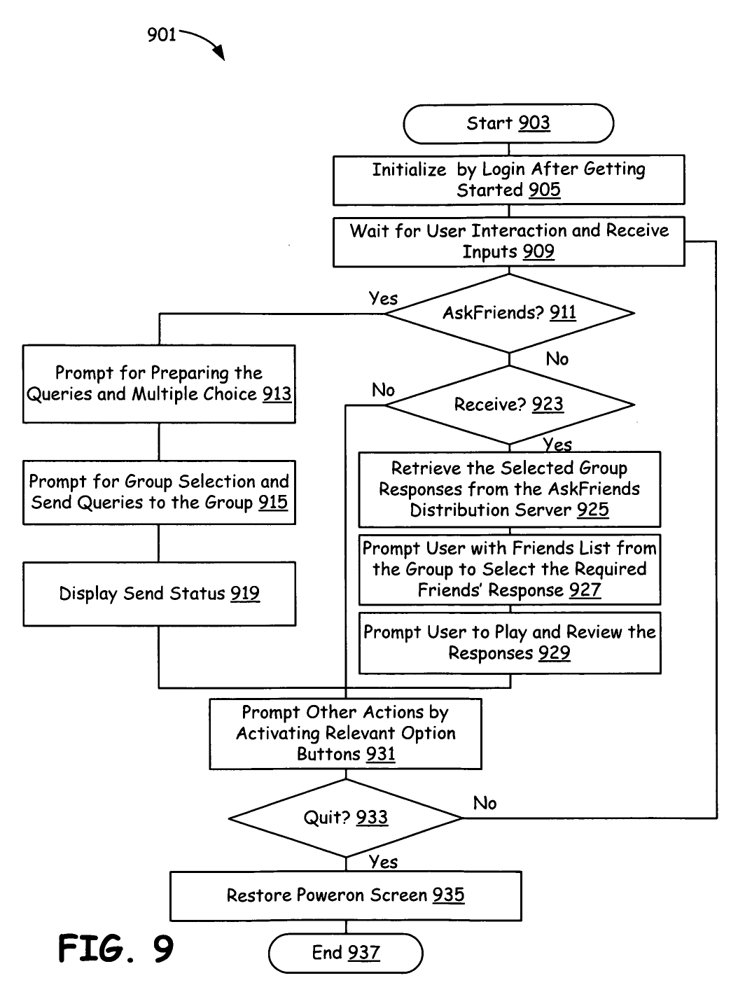

FIG. 9 is a flowchart showing exemplary operations performed by a service client (such as a Qello client from Vaudiofone) on a mobile phone in accordance with the present invention. The processing start at a starting block 903 when the client 123 of FIG. 1 is initialized. It then prompts the user to login at a next block 905. After user login, it waits for the user to perform one of several supported operations, and receives the inputs at a next block 909.

At a next decision block 911 the client tests whether the mobile phone user has activated a ‘AskFriends’ button 629 option selection on the client service screen 603 of FIG. 6. If it is determined to be true, processing proceeds to a next block 913, else to the decision block 923.

At the block 913 the client 123 of FIG. 1 prompts the user to create ad-hoc queries or multiple choices. At the next block 915 the client prompts group selection by presenting the Group list to the user. The user can select one or more friends group as targets for distribution of a query created or a questionnaire created or received. Subsequently the user selects ‘Send’ button 631 option of FIG. 6 to send the Query to one group or to all the selected groups. At the subsequent block 919 the client displays the send status to the mobile phone user. For example, a progress bar indicates the status of the send operation.

If the test at the decision block 911 returns false, at the next decision block 923 the client further tests whether the ‘Receive’ button 633 option of FIG. 6 is selected. It the test returns true it goes to the next block 925. At the block 925 it retrieves the selected group responses from the distribution server 141 of FIG. 1. The retrieved Answer/responses from each users of the selected Friends group are prompted to the user after downloading from the distribution server 141 of FIG. 1 in the order of the date/time they are received by default. The user will browse through the response list using the joystick 545 at the block 927. At the next block 929 the selected response is played using the ‘Play’ button 635 option of FIG. 6. As the answers in general is in the form of multimedia contents with the text, audio, video they will be played on speaker device and text and video are portrayed on the mobile phone display.

There are other options a user can select from the client screen 603 of FIG. 6. At the block 931 the user can select any of the other option buttons from the option button pane 627 of FIG. 6 to perform the respective operation.

At the next decision block 933 it tests whether the ‘Quit’ button 659 option is selected. If the test returns true the client 123 exits and the mobile phone restores the ‘Function Selection Screen’ of 503 of FIG. 5 and ends at the block 937. If the test returns false at the decision block 933, it goes to the previous block 909 and the operation is repeated.

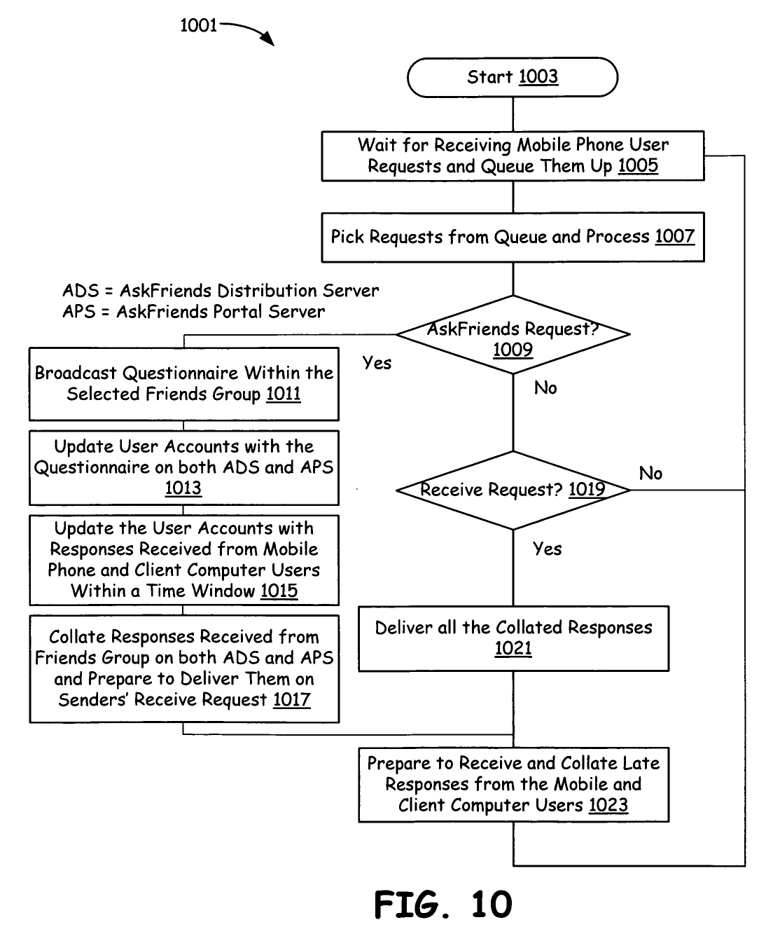

FIG. 10 is a flowchart for exemplary operations performed by the distribution server during the interaction with the mobile phone in accordance the present invention. Processing starts at a start block 1003. At a next block 1005 the distribution server 141 of FIG. 1 receives the request from mobile phone users and queues them up. At the next block 1007 the distribution server picks the requests from the queue and processes them for the subsequent action.

At the next decision block 1009 it tests whether the mobile phone user has selected the service using which he user can ask queries. For example, it tests whether the user has activated the “AskFriends” button 629 option. If the test returns true the ‘distribution server’ 141 receives the subsequently composed adhoc query or a questionnaire (or an interactive media, etc.) and broadcast it within the selected friends group or groups. At the subsequent block 1013, it updates the user accounts of the query sender and the query receiver with the questionnaire for later references (as the account history).

The account database on the ‘distribution server’ 141 of FIG. 1 is synchronized with that on the ‘portal server’ 161 of FIG. 1. As a result of this the databases on the two servers acquire the same latent contents. Subsequently at the block 1015 the ‘distribution server’ 141 receives the responses from the friends group. Some responses are received from the other mobile phones and some from client computers via the ‘portal server’ 161 of FIG. 1. The user accounts are updated with these responses for later references.

If the test at the decision block 1009 returns false the ‘distribution server’ 141 of FIG. 1 goes to the subsequent decision block 1019 and tests whether the mobile phone user selected the ‘Receive’ button 633 option of FIG. 6. If the test returns false the ‘distribution server’ goes back to the previous bock 1005 and the operation is repeated. If the test returns true at the decision block 1019 the ‘distribution server’ delivers all the responses to the query sender's mobile phone for his/her review. The delivery of responses is conducted after the distribution server has collected the responses into a group that can be delivered. In one embodiment, the collected responses are also collated before delivery. In general, the responses are delivered in 2 groups, the first one a few minutes after the query has been distributed, such as after 5 minutes, and the second one (delivered after a user configurable duration) after typically a day by default.

At the last block 1023 the ‘distribution server’ prepares to receive late responses from some of the members of the friends group for certain period of (late) time window. Those responses which may arrive after the (late) time window will be dropped for that query that has been sent. After the block 1023 it goes back to the previous block 1005 and the operation is repeated.

In general, the present invention makes it possible to communicate multimedia contents with a reliable delivery mechanism, providing support for ad-hoc queries. Such queries can be sent from a mobile phone or from a client computer with a browser. Similarly the responses/answers can be sent as a response to the ad-hoc queries/questionnaires/etc. in the form of multimedia content, such as a combination of a multiple choice selection and an audio message. The multimedia contents are displayed in a data driven mode, through a dynamic reformatting process for the contents, so as to not only suit the mobile device capability but also the elements in the received multimedia content. The interaction between a sender and his recipients (and between a recipient and the sender for the responses) is made more secure by employing display of personal photos, video clips, etc. as well as the playing of audio content (voice) which helps in identifying the member of the friends group so that the authenticity of the response can be determined by the respondent in most cases. The retrieval of the responses for the ad-hoc queries can be done from either mobile phones or client computers. Similarly delivering ad-hoc queries to the friends group members is conducted from mobile phones or from client computers from any part of the world.

As one of ordinary skill in the art will appreciate, the terms “operably coupled” and “communicatively coupled,” as may be used herein, include direct coupling and indirect coupling via another component, element, circuit, or module where, for indirect coupling, the intervening component, element, circuit, or module does not modify the information of a signal but may adjust its current level, voltage level, and/or power level. As one of ordinary skill in the art will also appreciate, inferred coupling (i.e., where one element is coupled to another element by inference) includes direct and indirect coupling between two elements in the same manner as “operably coupled” and “communicatively coupled.”

Although the present invention has been described in terms of query/response communication involving mobile phones and computers, it must be clear that the present invention also applies to other types of devices including mobile devices, laptops with a browser, a hand held device such as a PDA, a television, a set-top-box, a media center at home, and a computer communicatively coupled to the network.

The present invention has also been described above with the aid of method steps illustrating the performance of specified functions and relationships thereof. The boundaries and sequence of these functional building blocks and method steps have been arbitrarily defined herein for convenience of description. Alternate boundaries and sequences can be defined so long as the specified functions and relationships are appropriately performed. Any such alternate boundaries or sequences are thus within the scope and spirit of the claimed invention.

The present invention has been described above with the aid of functional building blocks illustrating the performance of certain significant functions. The boundaries of these functional building blocks have been arbitrarily defined for convenience of description. Alternate boundaries could be defined as long as the certain significant functions are appropriately performed. Similarly, flow diagram blocks may also have been arbitrarily defined herein to illustrate certain significant functionality. To the extent used, the flow diagram block boundaries and sequence could have been defined otherwise and still perform the certain significant functionality. Such alternate definitions of both functional building blocks and flow diagram blocks and sequences are thus within the scope and spirit of the claimed invention.

The present invention has been described with some implementation details that are for exemplary purposes. It also describes some of the aspects/features of the present invention that have been incorporated into an experimental mobile phone software called Qello client that has been developed by Vaudiofone.

One of average skill in the art will also recognize that the functional building blocks, and other illustrative blocks, modules and components herein, can be implemented as illustrated or by discrete components, application specific integrated circuits, processors executing appropriate software and the like or any combination thereof.

Moreover, although described in detail for purposes of clarity and understanding by way of the aforementioned embodiments, the present invention is not limited to such embodiments. It will be obvious to one of average skill in the art that various changes and modifications may be practiced within the spirit and scope of the invention, as limited only by the scope of the appended claims.

What is claimed is:

1. A network system comprising
a mobile device;
a mobile web system,
a group of other devices;
the mobile device providing a service that facilitates communicating with users of the group of other devices and receiving a collected responses from the group of other devices on the mobile device;
the mobile web system also providing the service that facilitates communicating with users of the group of other devices and receiving the collected responses from the group of other devices on the mobile web system;
the mobile web system receiving the collected responses from the group of other devices when the service is accessed by a user of the mobile device; and
the mobile device receiving of the collected responses from the group of other devices when the service is accessed by the user using the mobile web system.

2. The network system of claim 1 wherein the collected responses are collated and wherein the collected responses are each one of an audio response, a textual response, a multiple choice response, a video response, a graphic response and a combination of these.

3. The network system of claim 1 wherein the collected responses are received in one or more groups and wherein the collected responses are each one of an audio response, a textual response, a multiple choice response, a video response, a graphic response and a combination of these.

4. The network system of claim 1 wherein the group of other devices comprises at least one of an additional mobile device, a laptop with a browser, a hand held device, a television, a set-top-box and a computer communicatively coupled to the network.

5. The network system of claim 1 wherein a first user of the mobile device communicates an audio question form the mobile device to at least one of the users of the group of other devices and receives a collected responses on the mobile device from the at least one of the users.

6. The network system of claim 1 wherein a first user of the mobile device communicates an audio question from the mobile device to at least one of the users of the group of other devices and receives a collected responses from the at least one of the users on the mobile web system using a first computer communicatively coupled to the mobile web system.

7. The network system of claim 1 wherein a first user of the mobile device communicates an audio question from the mobile device to at least one of the users of the group of other devices and receives a collected responses from the at least one of the users on the mobile web system employing an appropriate user account on the mobile web system.

8. The network system of claim 1 wherein the group of other devices comprises other mobile devices and devices capable of communicatively coupling with the mobile web system and interacting with the mobile web system.

9. The network system of claim 1 wherein the service further comprises creating a questionnaire, communicating the questionnaire with the group of other devices and receiving the responses from users of the group of other devices.

10. The network system of claim 1 wherein the service further comprises creating an audio query, communicating the audio query to the group of other devices and receiving the responses from users of the group of other devices and reviewing the responses, wherein the responses are each one of an audio response, a textual response, a multiple choice response, a video response, a graphic response and a combination of these.

11. A network system that supports a plurality of mobile devices, the network system comprising:
a distribution server that interacts with the plurality of mobile devices to communicate a query and to receive a plurality of responses;
a portal server that provides web pages;
the distribution server distributing the query created by a first user and the collecting the plurality of responses;
a portal server facilitating the review of the plurality of responses by the first user; and
the distribution server also facilitating the review of the plurality of responses from one of the plurality of mobile devices by the first user.

12. The network system of claim 11 wherein the query is created by the first user using one of the portal server and the one of the plurality of mobile devices.

13. The network system of claim 12 wherein the query is an audio query and wherein the plurality of responses are all audio responses that are collected and presented in one or more groups to the first user.

14. The network system of claim 12 wherein the query is one of an audio query, a textual query, a video query and a combination of these.

15. The network system of claim 14 wherein each of the plurality of responses is one of an audio response, a textual response, a multiple choice response, a video response, a graphic response and a combination of these.

16. The network system of claim 1 1 wherein the portal server facilitates the creation of the query employing the web pages, wherein the web pages are accessed by the first user using a client computer comprising a web browser.

17. The network system of claim 16 wherein the portal server facilitates the review of the plurality of responses by the first user employing the web pages and the distribution server facilitates the of the plurality of responses by the first user employing one of the plurality of mobile devices.

18. The network system of claim 12 further comprising:
the portal server comprising a first user account created by the first user;
the portal server facilitating registration by a second user thereby creating a second user account on the portal server;
the portal server comprising a plurality of lists of recipients and facilitating the selection of at least one of the plurality of lists of recipients, by the first user, as a target list for distributing the query;
the target list comprising the second user account and a mobile phone number associated with a third user;
the distribution server facilitating communication of the query to the target list;
the portal server facilitating creation of a second response, among the plurality of responses, by the second user to the query employing the second user account and the query; and
the portal server facilitating creation of a third response, among the plurality of responses, by the third user to the query.

19. A server for communicating a query and receiving responses, the server comprising:
a plurality of lists of recipients, each of the plurality of lists of recipients represented by at least one of an email address, a phone number, a user account or a user name;
a query creation component that facilitates creation of a the query by a sender wherein the query comprises at least one of an audio question, a textual question, a multiple choice question, a video question and a combination of these;
a query response collection component that collects recipient responses from a plurality of recipients, wherein each of the plurality of recipients is associated with at least one of the plurality of list of recipients; and
a response presentation component that displays received recipient responses from the plurality of recipients to the sender.

20. The server of claim 19 further comprising:
the a plurality of lists of recipients comprising at least one list retrieved from an external social networking portal.

21. The server of claim 19 wherein the query is created by a user and communicated to at least one of the lists of recipients, the server further comprising:
a query response creation component that facilitates creation of the recipient responses by the users of the at least one of the lists of recipients, wherein each of the recipient responses comprises at least one of an audio response, a multiple choice response, a textual response, a video response and a combination of these.
